(19) United States
(12) Patent Application Publication
(10) Pub. No.: US 2021/0135178 A1
(43) Pub. Date: May 6, 2021

(54) NONAQUEOUS ELECTROLYTE SECONDARY BATTERY SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Takahiro MATSUO, Niihama-shi (JP); Yoshinori SATO, Niihama-shi (JP); Atsuhiro TAKATA, Niihama-shi (JP)

(21) Appl. No.: 17/088,126

(22) Filed: Nov. 3, 2020

(30) Foreign Application Priority Data
Nov. 6, 2019 (JP) 2019-201723

(51) Int. Cl. H01M 2/16; H01M 4/13; H01M 10/0525

(52) U.S. Cl. CPC H01M 2/1653; H01M 2/1673; H01M 2004/028; H01M 4/13; H01M 10/0525; H01M 2/1686

(57) ABSTRACT

An object of an embodiment of the disclosure is to provide a nonaqueous electrolyte secondary battery separator having an excellent withstand voltage property. A nonaqueous electrolyte secondary battery separator in accordance with an embodiment of the disclosure includes a polyolefin porous film having a thickness of 4 μm to 40 μm. The polyolefin porous film does not break in a puncture test in which a pin having a diameter of 1 mm and a tip radius of 0.5R is thrust at a speed of 1 mm/s to a depth of 2.5 mm.

This Nonprovisional application claims priority under 35 U.S.C. § 119 on Patent Application No. 2019-201723 filed in Japan on Nov. 6, 2019, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

As a separator for use in such a nonaqueous electrolyte secondary battery, a porous film containing polyolefin as a main component is mainly used. Examples of the porous film containing polyolefin as a main component encompass a porous film produced by the method disclosed in Patent Literature 1, which includes a step of stretching a resin composition containing a polyolefin-based resin.

### CITATION LIST

### Patent Literature

[Patent Literature 1]

Japanese Patent Application Publication Tokukaihei No. 11-130900

### SUMMARY OF INVENTION

### Technical Problem

However, a conventional nonaqueous electrolyte secondary battery separator such as that described above has room for improvement in terms of a withstand voltage property.

An object of an aspect of the present invention is to achieve a nonaqueous electrolyte secondary battery separator that has an excellent withstand voltage property and makes it possible to improve the safety of a nonaqueous electrolyte secondary battery.

### Solution to Problem

As a result of diligent research, the inventors of the present invention arrived at the present invention after discovering that an excellent withstand voltage property is achieved in a nonaqueous electrolyte secondary battery separator that includes a polyolefin porous film that does not break in a puncture test carried out under specific conditions.

The present invention includes the following aspects.

[1] A nonaqueous electrolyte secondary battery separator including:

a polyolefin porous film,

the polyolefin porous film having a thickness of 4 μm to 40 μm,

the polyolefin porous film not breaking in a puncture test in which a pin having a diameter of 1 mm and tip radius of 0.5R is thrust into the polyolefin porous film at a speed of 1 mm/s to a depth of 2.5 mm,

where breaking of the polyolefin porous film refers to the occurrence of a point at which stress in the polyolefin porous film, which increases simultaneously with commencement of the puncture test, decreases by not less than 200 gf.

[2] The nonaqueous electrolyte secondary battery separator according to [1], wherein the polyolefin porous film has a MD breaking elongation ratio of not less than 20% GL,

the MD breaking elongation ratio being measured by a method in conformance with the JIS K7127 standard.

[3] The nonaqueous electrolyte secondary battery separator according to [1] or [2], further including:

an insulating porous layer including one or more types of resin selected from the group consisting of polyolefins, (meth)acrylate-based resins, fluorine-containing resins, polyamide-based resins, polyester-based resins, and water-soluble polymers.

[4] The nonaqueous electrolyte secondary battery separator according to [3], wherein the resin is an aramid resin.

[5] A nonaqueous electrolyte secondary battery member including:

a positive electrode;

a nonaqueous electrolyte secondary battery separator according to any one of [1] to [4]; and

a negative electrode,

the positive electrode,

the nonaqueous electrolyte secondary battery separator, and the negative electrode being arranged in this order.

[6] A nonaqueous electrolyte secondary battery including:

the nonaqueous electrolyte secondary battery separator according to any one of [1] to [4].

### Advantageous Effects of Invention

A nonaqueous electrolyte secondary battery separator in accordance with an embodiment of the present invention brings about the effects of having an excellent withstand voltage property and making it possible to improve the safety of a nonaqueous electrolyte secondary battery.

### BRIEF DESCRIPTION OF DRAWINGS

FIG. 1 illustrates unevenness in the surface of an electrode probe of a withstand voltage tester used in the Examples.

### DESCRIPTION OF EMBODIMENTS

The following description will discuss embodiments of the present invention. Note, however, that the present invention is not limited to these embodiments. The present invention is not limited to arrangements described below, but may be altered in various ways by a skilled person within the scope of the claims. The present invention also encompasses, in its technical scope, any embodiment derived by combining technical means disclosed in differing embodiments. Any numerical range expressed as “A to B” herein means “not less than A and not more than B” unless otherwise stated.

Herein, the term “machine direction” (MD) refers to a direction which a polyolefin resin composition in sheet form, a primary sheet, and a porous film are conveyed in the below-described method of producing the porous film. The term “transverse direction” (TD) refers to a direction which is (i) perpendicular to the MD and (ii) parallel to the surface of the polyolefin resin composition in sheet form, the surface of the primary sheet, and the surface of the porous film.

### Embodiment 1: Nonaqueous Electrolyte Secondary Battery Separator

A nonaqueous electrolyte secondary battery separator in accordance with Embodiment 1 of the present invention includes a polyolefin porous film, the polyolefin porous film having a thickness of 4 μm to 40 μm, the polyolefin porous film not breaking in a puncture test in which a pin having a diameter of 1 mm and tip radius of 0.5R is thrust into the polyolefin porous film at a speed of 1 mm/s to a depth of 2.5 mm.

Here, breaking of the polyolefin porous film refers to the occurrence of a point at which stress in the polyolefin porous film, which increases simultaneously with commencement of the puncture test, decreases by not less than 200 gf. In other words, the polyolefin porous film is determined as “not breaking” in a case where, in the puncture test, after commencement of the puncture test, the pin of the puncture test apparatus reaches a depth of 2.5 mm without the measured stress decreasing by 200 gf or more.

The nonaqueous electrolyte secondary battery separator in accordance with an embodiment of the present invention includes a polyolefin porous film. Hereinafter, the polyolefin porous film may be referred to simply as a “porous film”.

The nonaqueous electrolyte secondary battery separator in accordance with an embodiment of the present invention may be a nonaqueous electrolyte secondary battery separator that consists of the porous film. The nonaqueous electrolyte secondary battery separator in accordance with an embodiment of the present invention may be a nonaqueous electrolyte secondary battery separator that is a laminate including the porous film and an insulating porous layer (described later). Hereinafter, a nonaqueous electrolyte secondary battery separator that is a laminate including the porous film and the insulating porous layer (described later) may also be referred to as a “nonaqueous electrolyte secondary battery laminated separator”. The nonaqueous electrolyte secondary battery separator in accordance with an embodiment of the present invention may, as necessary, include a publicly known porous layer other than the insulating porous layer, such as a heat-resistant layer, an adhesive layer, and/or a protective layer as described later.

The porous film contains a polyolefin-based resin. Typically, the porous film contains the polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the entire amount of materials of which the porous film is made.

The porous film has many pores connected to one another. This allows a gas and a liquid to pass through the polyolefin porous film from one side to the other side.

The porous film has a thickness of 4 μm to 40 μm. The thickness of the porous film is preferably 5 μm to 20 μm. The porous film having a film thickness of not less than 4 μm makes it possible to sufficiently prevent an internal short circuit in a battery. The porous film having a thickness of not more than 40 μm makes it possible to prevent the nonaqueous electrolyte secondary battery from being large in size.

The porous film is a porous film that does not break in a puncture test in which a pin having a diameter of 1 mm and tip radius of 0.5R is thrust into the polyolefin porous film at a speed of 1 mm/s to a depth of 2.5 mm. Hereinafter, the puncture test carried out using the above conditions may also be referred to as a “specialized puncture test”.

In the specialized puncture test, the method of fixing the porous film when the pin is thrust into the porous film is not limited to a particular method. Examples of possible methods encompass a method of fixing the porous film by using a washer having a diameter of 12 mm.

During charging and discharging of a nonaqueous electrolyte secondary battery, electrodes of the battery expand and shrink, and unevenness occurs in the surface of the electrodes. As such, during charging and discharging of the nonaqueous electrolyte secondary battery, as a voltage is applied, expansion of the electrode causes a load to be applied to the nonaqueous electrolyte secondary battery separator included in the nonaqueous electrolyte secondary battery. Because of this, during charging and discharging of the nonaqueous electrolyte secondary battery, the load may damage the nonaqueous electrolyte secondary battery separator and result in a decrease in the withstand voltage of the nonaqueous electrolyte secondary battery separator.

“Breaking” of the porous film refers to the occurrence of a point at which, in the specialized puncture test, stress in the porous film, which increases simultaneously with commencement of the specialized puncture test, decreases by not less than 200 gf.

If the porous film that has a thickness within the above range and does not break in the specialized puncture test, it means that (i) the porous film is unlikely to break when a particular load is applied and (ii) can easily be elongated by that load.

As such, the nonaqueous electrolyte secondary battery separator in accordance with an embodiment of the present invention, which includes the porous film that has a thickness within the above range and does not break in the specialized puncture test, presumably deforms so as to conform to the unevenness in the surface of the electrodes occurring during charging and discharging. This presumably reduces damage to the nonaqueous electrolyte secondary battery separator caused by the load applied during expansion of the electrodes, and reduces or prevents a decrease in the withstand voltage. Presumably as a result of this, the nonaqueous electrolyte secondary battery separator in accordance with an embodiment of the present invention exhibits an excellent withstand voltage property.

The porous film has an MD breaking elongation ratio of preferably not less than 20% GL (Gage Length), and more preferably not less than 30% GL. An upper limit of the MD breaking elongation ratio is not particularly limited, but normally can be 300% GL or less. The MD breaking elongation ratio is measured by a method in conformance with the JIS K7127 standard.

The MD breaking elongation ratio is expressed as a ratio (%) of (i) the length by which the porous film has elongated in the MD at the time the porous film breaks when carrying out an operation to elongate the porous film in the MD to (ii) the length in the MD of the porous film prior to carrying out the operation.

It is known that the porous film typically has less strength with respect to elongation in the MD than with respect to elongation in the TD. As such, when a load is applied due to the expansion of the electrodes, the porous film may break due to elongation in the MD and, as a result, there may be a decrease in the withstand voltage of the nonaqueous electrolyte secondary battery separator including the porous film.

The MD breaking elongation ratio of the porous film being not less than 20% GL therefore presumably renders the porous film less prone to damage caused by elongation in the MD, and, as a result, presumably makes it possible to prevent or reduce a decrease in the withstand voltage of the nonaqueous electrolyte secondary battery separator.

The porous film has a TD breaking elongation ratio of preferably not less than 50% GL, and more preferably not less than 60% GL. An upper limit of the TD breaking elongation ratio is not particularly limited, but normally can be 300% GL or less. The TD breaking elongation ratio is measured by a method in conformance with the JIS K7127 standard.

Similarly to the MD breaking elongation ratio, the TD breaking elongation ratio of the porous film is expressed as a ratio (%) of (i) the length by which the porous film has elongated in the TD at the time the porous film breaks when carrying out an operation to elongate the porous film in the TD to (ii) the length in the TD of the porous film prior to carrying out the operation.

However, in a sheet-type porous film, i.e., a porous film which has been processed to a predetermined size, it can be difficult to distinguish between the TD and the MD. In such a case, if the sheet-type porous film is rectangular, measurements can be carried out to determine (i) the breaking elongation ratio when the porous film is elongated in a direction parallel to one of the sides of the rectangle and (ii) the breaking elongation ratio when the porous film is elongated in a direction perpendicular to that side of the rectangle. Because a porous film typically has less strength with respect to elongation in the MD as described above, out of the two breaking elongation ratios measured as above, the smaller value is considered to be the value of the MD breaking elongation ratio, and the larger value is considered to be the value of the TD breaking elongation ratio.

If the TD and MD of a porous film cannot be distinguished and the porous film is not rectangular in shape, the porous film can be elongated in a plurality of discretionarily chosen directions, and a breaking elongation ratio can be measured for each of the directions of elongation. Thereafter, out of the breaking elongation ratios measured, the smallest value is considered to be the value of the MD breaking elongation ratio. A direction perpendicular to the elongation direction used in the measurement of the MD breaking elongation ratio is considered to be the TD, and the breaking elongation ratio in that direction is considered to be the TD breaking elongation ratio. Note that in the present specification, the “shape” of a porous film refers to the shape of a surface of the separator which surface is perpendicular to the thickness-wise direction of the separator.

The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000, because such a resin improves the strength of the porous film and the nonaqueous electrolyte secondary battery separator including the porous film.

The polyolefin-based resin is not limited to a particular one, but possible examples encompass thermoplastic resins such as homopolymers and copolymers which are each obtained by polymerizing a monomer(s) such as ethylene, propylene, 1-butene, 4-methyl-1-pentene, and/or 1-hexene. Examples of such homopolymers encompass polyethylene, polypropylene, and polybutene. Examples of such copolymers encompass an ethylene-propylene copolymer.

Among the above examples, polyethylene is more preferable because use of polyethylene makes it possible to prevent a flow of an excessively large electric current at a lower temperature in the nonaqueous electrolyte secondary battery separator. Preventing the flow of an excessively large electric current is also called “shutdown.” Examples of the polyethylene encompass low-density polyethylene, high-density polyethylene, linear polyethylene (ethylene-α-olefin copolymer), and ultra-high molecular weight polyethylene having a weight-average molecular weight of not less than 1,000,000. Among these examples, the ultra-high molecular weight polyethylene having a weight-average molecular weight of not less than 1,000,000 is more preferable.

The polyolefin-based resin may contain polyolefin in which the number of long chain branch points per molecule is preferably 20 or less, and more preferably 10 or less. The number of long chain branch points is, for example, a value calculated from a conformation plot obtained using GPC-MALS. The conformation plot is a logarithmic plot of molecular radius versus molecular weight.

The polyolefin porous film typically has a weight per unit area of preferably 4 g/m² to 20 g/m², and more preferably 5 g/m² to 12 g/m², so as to allow a nonaqueous electrolyte secondary battery to have a higher weight energy density and a higher volume energy density.

The polyolefin porous film has an air permeability of preferably 110 sec/100 mL to 200 sec/100 mL, and more preferably 110 sec/100 mL to 190 sec/100 mL, in terms of Gurley values, because such an air permeability enables a sufficient ion permeability.

The porous film has a puncture strength of preferably not less than 350 gf, more preferably not less than 400 gf, and even more preferably not less than 450 gf. This puncture strength is measured not by the specialized puncture test, but by a method including the following steps (i) and (ii):

(i) the porous film is fixed with a washer having a diameter of 12 mm, and thereafter a pin (diameter of 1 mm; tip radius of 0.5R) is thrust into the porous film at a speed of 10 mm/sec to a depth of 10 mm; and
(ii) the maximum stress (gf) occurring when the pin is thrust into the porous film in step (i) is measured, and the measured value is considered to be the puncture strength of the porous film.

The porous film has a porosity of preferably 20% by volume to 80% by volume, and more preferably 30% by volume to 75% by volume, so as to (i) retain a larger amount of electrolyte and (ii) obtain the function of reliably preventing (shutting down) a flow of an excessively large electric current at a lower temperature.

The pore diameter of each pore of the porous film is preferably not more than 0.3 μm and more preferably not more than 0.14 μm, in view of (i) achieving sufficient ion permeability and (ii) preventing particles which constitute an electrode from entering the polyolefin porous film.

<Method of Producing Polyolefin Porous Film>

A method of producing a polyolefin porous film in an embodiment of the present invention is not limited to a particular method, but specific examples encompass a method including the following steps (A) to (C):

(A) obtaining a polyolefin resin composition by melting and kneading, in a kneader, a polyolefin-based resin and optionally an additive such as a pore forming agent;

(B) obtaining a primary sheet by (i) extruding, from a T-die of an extruder, the polyolefin resin composition thus obtained and (ii) forming the polyolefin resin composition into a sheet by stretching the polyolefin resin composition in a first direction while cooling the polyolefin resin composition; and

(C) stretching the primary sheet in a second direction differing from the first direction, while causing the primary sheet to shrink in the first direction.

In the step (A), the polyolefin-based resin is used in an amount of preferably 6% by weight to 45% by weight, and more preferably 9% by weight to 36% by weight, with respect to 100% by weight of the polyolefin resin composition to be obtained.

The pore forming agent is not limited to a particular one, but possible examples encompass plasticizers and inorganic bulking agents. The inorganic bulking agents are not limited to particular ones. Specific examples of the inorganic bulking agents encompass inorganic fillers and calcium carbonate. The plasticizers are not limited to particular ones. Examples of the plasticizers encompass low molecular weight hydrocarbons such as liquid paraffin.

Examples of the additive encompass publicly known additives other than the pore forming agent, which additives can be optionally added to an extent that does not cause a deterioration in effects of the present invention. Examples of the publicly known additives encompass antioxidants.

In the step (B), the method of obtaining the primary sheet is not limited to a particular method. The primary sheet may be obtained by a sheet forming method such as inflation processing, calendering, T-die extrusion, or a Scaif method.

A sheet formation temperature in the sheet forming method, such as a T-die extrusion temperature in T-die extrusion, is preferably 200° C. to 280° C., and more preferably 220° C. to 260° C.

Examples of methods for obtaining the primary sheet with a high degree of precision in terms of thickness encompass a method of roll-molding the polyolefin resin composition with use of a pair of rotational molding tools whose surface temperatures have been adjusted to be higher than the melting point of the polyolefin-based resin contained in the polyolefin resin composition. The surface temperature of the rotational molding tools is preferably not less than 5° C. higher than the melting point of the polyolefin-based resin. An upper limit of the surface temperature is preferably not more than 30° C. higher than the melting point of the polyolefin-based resin, and more preferably not more than 20° C. higher than the melting point of the polyolefin-based resin. Examples of the pair of rotational molding tools encompass rollers and belts. The respective circumferential velocities of the two rotational molding tools do not necessarily have to be identical. The respective circumferential velocities need only be within approximately 5% of each other. The primary sheet may include a plurality of individual sheets obtained via the above sheet forming method which individual sheets have been laminated together.

When roll-molding the polyolefin resin composition with use of a pair of rotational molding tools, the polyolefin resin composition discharged in strand form may be introduced between the rotational molding tools directly from the extruder, or may first be formed into pellets.

A stretch ratio employed in the step (B) is preferably 1.1 times to 1.9 times, and more preferably 1.2 times to 1.8 times. A stretching temperature employed in the step (B) is preferably 120° C. to 160° C., and more preferably 130° C. to 155° C.

The method of cooling the polyolefin resin composition in the step (B) may be, for example, a method of bringing the polyolefin resin composition into contact with a cooling medium such as cool air or coolant water, or a method of bringing the polyolefin resin composition into contact with a cooling roller. The method of involving contact with a cooling roller is preferable.

The first direction in the step (B) is preferably the MD. Setting the first direction to be the MD is preferable in that doing so makes it possible, in a “relaxation operation” (described later), to improve the strength of the porous film with respect to elongation in the MD (which is normally the direction of least strength) and to efficiently improve the strength of the entire porous film with respect to elongation.

If the polyolefin resin composition and the primary sheet contain a pore forming agent, the method of producing the polyolefin porous film includes a step of removing the pore forming agent by cleaning the sheet stretched in the step (B) or the sheet stretched in the step (C) with use of cleaning liquid. The step of removing the pore forming agent is performed between the steps (B) and (C), or after the step (C).

The cleaning liquid is not limited to a particular one, as long as it is a solvent capable of removing the pore forming agent. Examples of the cleaning liquid encompass an aqueous hydrochloric acid solution, heptane, and dichloromethane.

In the step (C), the stretching temperature employed when performing stretching in the second direction is preferably 80° C. to 120° C., and more preferably 80° C. to 115° C. The stretch ratio employed when performing stretching in the second direction is preferably 2 times to 12 times, and more preferably 4 times to 10 times.

In the step (C), carrying out an operation to shrink the primary sheet in the first direction when stretching the primary sheet in the second direction makes it possible to improve the ability of the obtained porous film to elongate in the first direction. This makes it possible to improve the strength of the obtained porous film with respect to elongation and, as a result, makes it possible to suitably produce a porous film that does not break in the specialized puncture test. Note that, hereinafter, an operation to shrink the primary sheet in the first direction may also be referred to as a “relaxation operation”.

The second direction in the step (C) is a direction differing from the first direction. The second direction is preferably orthogonal to the first direction. For example, if the first direction is the MD, the second direction can be the TD.

The step (C) (the step of stretching the primary sheet in a second direction differing from the first direction, while causing the primary sheet to shrink in the first direction) can encompass the following aspects (I) and (II):

(I) a step in which shrinking of the primary sheet in the first direction and stretching of the primary sheet in the second direction are carried out simultaneously; and
(II) a step in which the stretching of the primary sheet in the second direction is carried out sometime while causing the primary sheet to shrink in the first direction (that is, the shrinking in the first direction and the stretching in the second direction do not necessarily need to commence at the same time).

As described above, it is known that the porous film typically has less ability to elongate in the MD. As such, performing the relaxation operation in the MD makes it possible to improve the ability of the porous film to elongate in the MD, and, as a result, makes it possible to efficiently improve strength of the entire porous film with respect to elongation. The relaxation operation therefore makes it possible to more suitably produce a porous film that does not break in the specialized puncture test.

A relaxation ratio in the relaxation operation is expressed by the following Formula (1):

Relaxation ratio (%)=[{(length of the primary sheet in the first direction prior to the stretching step)−(length of the porous film in the first direction after the stretching step)}/(length of the primary sheet in the first direction prior to the stretching step)]×100 (1)

If the first direction is the MD, the relaxation ratio can also be called an “MD relaxation ratio”.

Note that the length of the primary sheet does not necessarily have to be measured as the entire length of the primary sheet. The following description will discuss a specific example of calculating the relaxation ratio.

If the stretching step is carried out for a primary sheet cut to a relatively small size, the relaxation ratio can be calculated as follows. It is assumed here that the primary sheet is square or rectangular in shape. In such a case, the four sides of the primary sheet are held by holding members. The primary sheet is shrunk in the first direction by decreasing the distance between the holding members that hold the two sides of the primary sheet which two sides are perpendicular to the first direction. In other words, the primary sheet is shrunk in the first direction by decreasing the distance between holding members that are opposite each other in the first direction. Simultaneously, the primary sheet is stretched in the second direction by increasing the distance between the holding members that hold the two sides of the primary sheet which two sides are parallel to the first direction, i.e., which two sides are perpendicular to the second direction. In other words, the primary sheet is stretched in the second direction by increasing the distance between holding members that are opposite each other in the second direction. In such a case, the relaxation ratio is calculated using the following Formula (1a).

Relaxation ratio (%)=[{(distance between holding members opposite each other in the first direction prior to stretching step)−(distance between holding members opposite each other in the first direction after stretching step))}/(distance between holding members opposite each other in the first direction prior to stretching step)]×100 (1a)

If the stretching step is carried out for a long primary sheet, the relaxation ratio can be calculated as follows. Each end of the primary sheet in the second direction is held by a plurality of holding members. The plurality of holding members are provided along the first direction. The primary sheet is shrunk in the first direction by decreasing the distance between holding members that are adjacent in the first direction. At the same time, the primary sheet is stretched in the second direction by increasing the distance between holding members that are opposite each other in the second direction. In such a case, the relaxation ratio is calculated using the following Formula (1b).

Relaxation ratio (%)=[{(distance between holding members adjacent to each other in the first direction prior to stretching step)−(distance between holding members adjacent to each other in the first direction after stretching step))}/(distance between holding members adjacent to each other in the first direction prior to stretching step)]×100 (1b)

The relaxation ratio in the step (C) is preferably not less than 10%, and more preferably not less than 30%, in terms of suitably producing a porous film that does not break in the specialized puncture test. The relaxation ratio is preferably not more than 60%, and more preferably not more than 50%.

The porous film may be obtained in a manner such that, in the step (C), the primary sheet that has been stretched in the second direction is annealed by carrying out a heat treatment at a specific temperature. The annealing is carried out at a temperature of preferably 110° C. to 130° C., and more preferably 115° C. to 128° C. The annealing is carried out for a period of preferably not less than 15 seconds to less than 20 minutes, and more preferably not less than 1 minute to not more than 15 minutes.

<Insulating Porous Layer>

If the nonaqueous electrolyte secondary battery separator in accordance with an embodiment of the present invention is a nonaqueous electrolyte secondary battery laminated separator, the nonaqueous electrolyte secondary battery laminated separator preferably includes the polyolefin porous film and an insulating porous layer formed on the polyolefin porous film.

The insulating porous layer is typically a resin layer containing a resin. The porous layer is preferably a heat-resistant layer or an adhesive layer. It is preferable that the resin of which the insulating porous layer is made be insoluble in the electrolyte of the battery and be electrochemically stable when the battery is in normal use. Hereinafter, the insulating porous layer may also be referred to simply as a “porous layer”.

The porous layer is formed on one surface or on both surfaces of the polyolefin porous film, as necessary. If the porous layer is formed on one surface of the polyolefin porous film, the porous layer is preferably formed on a surface of the polyolefin porous film which surface faces a positive electrode of a nonaqueous electrolyte secondary battery to be produced, and more preferably on a surface of the polyolefin porous film which surface comes into contact with the positive electrode.

Specific examples of the resin encompass polyolefins, (meth)acrylate-based resins, fluorine-containing resins, polyamide-based resins, polyimide-based resins, polyester-based resins, rubbers, resins with a melting point or glass transition temperature of not lower than 180° C., water-soluble polymers, polycarbonate, polyacetal, and polyether ether ketone.

Of the above resins, polyolefins, (meth)acrylate-based resins, fluorine-containing resins, polyamide-based resins, polyester-based resins, and water-soluble polymers are preferable.

Preferable examples of the polyolefins encompass polyethylene, polypropylene, polybutene, and an ethylene-propylene copolymer.

Examples of the fluorine-containing resins encompass polyvinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichoroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

As the polyamide-based resins, aramid resins such as aromatic polyamides and wholly aromatic polyamides are preferable.

Specific examples of the aramid resins encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among these aramid resins, poly(paraphenylene terephthalamide) is more preferable.

Preferable examples of the polyester-based resins encompass (i) aromatic polyesters such as polyarylates and (ii) liquid crystal polyesters.

Examples of the rubbers encompass a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the resins each having a melting point or a glass transition temperature of not lower than 180° C. encompass polyphenylene ether, polysulfone, polyether sulfone, polyphenylene sulfide, polyetherimide, polyamide imide, and polyether amide.

Examples of the water-soluble polymers encompass polyvinyl alcohol, polyethylene glycol, cellulose ether, sodium alginate, polyacrylic acid, polyacrylamide, and polymethacrylic acid.

The porous layer may contain only one of the above resins or two or more of the above resins in combination.

The porous layer may contain fine particles. The term “fine particles” herein means organic fine particles or inorganic fine particles generally referred to as a filler.

Therefore, if the porous layer contains fine particles, the above-described resin contained in the porous layer functions as a binder resin for (i) binding fine particles together and (ii) binding fine particles to the porous film. The fine particles are preferably electrically insulating fine particles.

Examples of the organic fine particles that can be contained in the porous layer encompass resin fine particles. Specific examples of the inorganic fine particles that can be contained in the porous layer encompass fillers made of inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. It is possible to use only one type of the above fine particles, or two or more types of the above fine particles in combination.

Of the above fine particles, fine particles made of inorganic matter are suitable. More preferable are fine particles made of an inorganic oxide such as silica, calcium oxide, magnesium oxide, titanium oxide, alumina, mica, zeolite, aluminum hydroxide, or boehmite. Still more preferable are fine particles made of at least one selected from the group consisting of silica, magnesium oxide, titanium oxide, aluminum hydroxide, boehmite, and alumina. Particularly preferable are fine particles made of alumina.

The porous layer contains the fine particles in an amount of preferably 1% by volume to 99% by volume, and more preferably 5% by volume to 95% by volume, with respect to 100% by volume of the porous layer. Setting the amount of the fine particles to fall within the above range makes it less likely that the resin or the like will block a void which is formed when the fine particles come into contact with each other. This makes it possible to achieve sufficient ion permeability and an appropriate weight per unit area of the porous layer.

The porous layer can contain two or more kinds of fine particles in combination which two or more kinds differ from each other in particle size or specific surface area.

The porous layer has a thickness of preferably 0.5 μm to 15 μm per layer, and more preferably 2 μm to 10 μm per layer. Setting the thickness of the porous layer to be not less than 0.5 μm per layer makes it possible to sufficiently prevent an internal short circuit caused by, for example, breakage of the nonaqueous electrolyte secondary battery, and also to retain a sufficient amount of the electrolyte in the porous layer. Setting the thickness of the porous layer to be not more than 15 μm per layer makes it possible to reduce or prevent a decrease in a rate characteristic or cycle characteristic.

The weight per unit area of the porous layer is preferably 1 g/m₂ to 20 g/m² per layer and more preferably 4 g/m² to 10 g/m² per layer.

A volume per square meter of all component(s) contained in the porous layer is preferably 0.5 cm³ to 20 cm³ per layer, more preferably 1 cm³ to 10 cm³ per layer, and even more preferably 2 cm³ to 7 cm³ per layer.

For the purpose of achieving sufficient ion permeability, the porosity of the porous layer is preferably 20% by volume to 90% by volume, and more preferably 30% by volume to 80% by volume. In order for a nonaqueous electrolyte secondary battery laminated separator to have sufficient ion permeability, the pore diameter of each pore of the porous layer is preferably not more than 3 μm, and more preferably not more than 1 μm.

<Nonaqueous Electrolyte Secondary Battery Laminated Separator>

The nonaqueous electrolyte secondary battery separator in accordance with an embodiment of the present invention may be a nonaqueous electrolyte secondary battery laminated separator.

The nonaqueous electrolyte secondary battery laminated separator has a thickness of preferably 5.5 μm to 45 μm and more preferably 6 μm to 25 μm.

The nonaqueous electrolyte secondary battery laminated separator has an air permeability of preferably 100 sec/100 mL to 350 sec/100 mL and more preferably 100 sec/100 mL to 300 sec/100 mL, in terms of Gurley values.

The nonaqueous electrolyte secondary battery laminated separator has a puncture strength of preferably not less than 350 gf, more preferably not less than 400 gf, and even more preferably not less than 450 gf. The puncture strength is measured using a method similar to that used for the porous film.

The nonaqueous electrolyte secondary battery separator in accordance with an embodiment of the present invention may include, as necessary, another porous layer other than the porous film and the porous layer, provided that the other porous layer does not prevent attainment of an object of an embodiment of the present invention. Examples of the other porous layer encompass publicly known porous layers such as a heat-resistant layer, an adhesive layer, and a protective layer.

<Method of Producing Porous Layer and Nonaqueous Electrolyte Secondary Battery Laminated Separator>

A method of producing the insulating porous layer in an embodiment of the present invention and the nonaqueous electrolyte secondary battery laminated separator in accordance with an embodiment of the present invention may be, for example, a method involving: applying a coating solution to one or both surfaces of the porous film, the coating solution containing the resin contained in the porous layer; and depositing the porous layer by drying the coating solution.

If the porous layer is to be deposited on both surfaces of the porous film, (a) the porous film may be deposited on both surfaces of the porous film simultaneously, or (b) the coating solution may be applied to a first surface of the porous film and then dried so as to form a porous layer on the first surface, and then subsequently the coating solution can be applied to a second surface of the porous film and then dried so as to form a porous layer on the second surface.

Note that, before the coating solution is applied to one or both surfaces of the porous film, the one or both surfaces of the polyolefin porous film to which the coating solution is to be applied can be subjected to a hydrophilization treatment as necessary.

The coating solution contains a resin to be contained in the porous layer. The coating solution may contain the above-described fine particles which may be contained in the porous layer. The coating solution can be prepared typically by (i) dissolving, in a solvent, the resin that can be contained in the porous layer and (ii) dispersing, in the solvent, the fine particles. The solvent in which the resin is to be dissolved also serves as a dispersion medium in which the fine particles are to be dispersed. Depending on the solvent, the resin may be an emulsion.

The solvent is not limited to any particular one, provided that (i) the solvent does not have an adverse effect on the polyolefin porous film, (ii) the solvent allows the resin to be uniformly and stably dissolved in the solvent, and (iii) the solvent allows the fine particles to be uniformly and stably dispersed in the solvent. Specific examples of the solvent encompass water and organic solvents. It is possible to use only one kind of the solvent, or two or more kinds of the solvent in combination.

The coating solution may be formed by any method, provided that the coating solution can satisfy conditions, such as a resin solid content (resin concentration) and/or a fine particle amount, which are necessary for obtaining a desired porous layer. Specific examples of the method of forming the coating solution encompass a mechanical stirring method, an ultrasonic dispersion method, a high-pressure dispersion method, and a media dispersion method. Further, the coating solution may contain, as a component(s) other than the resin and the fine particles, an additive(s) such as a disperser, a plasticizer, a surfactant, and/or a pH adjustor, provided that the additive does not prevent the object of an embodiment of the present invention from being attained. The additive(s) may be contained in an amount that does not prevent the object of an embodiment of the present invention from being attained.

A method of applying the coating solution to the porous film, that is, a method of forming a porous layer on a surface of the porous film is not limited to any particular one. The porous layer can be formed by, for example, (i) a method including the steps of applying the coating solution directly to a surface of the porous film and then removing the solvent, (ii) a method including the steps of applying the coating solution to an appropriate support, removing the solvent to form a porous layer, then pressure-bonding the porous layer to the porous film, and subsequently peeling the support off, and (iii) a method including the steps of applying the coating solution to a surface of an appropriate support, then pressure-bonding the porous film to that surface, then peeling the support off, and subsequently removing the solvent.

The coating solution can be applied by a conventionally publicly known method. Specific examples of such a method include a gravure coater method, a dip coater method, a bar coater method, and a die coater method.

The solvent is typically removed by a drying method. The solvent contained in the coating solution may be replaced with another solvent before a drying operation.

### Embodiment 2: Nonaqueous Electrolyte Secondary Battery Member, Embodiment 3: Nonaqueous Electrolyte Secondary Battery

A nonaqueous electrolyte secondary battery member in accordance with Embodiment 2 of the present invention includes a positive electrode, the nonaqueous electrolyte secondary battery separator in accordance with Embodiment 1 of the present invention, and a negative electrode, the positive electrode, the nonaqueous electrolyte secondary battery separator, and the negative electrode being arranged in this order.

A nonaqueous electrolyte secondary battery in accordance with Embodiment 3 of the present invention includes the nonaqueous electrolyte secondary battery separator in accordance with Embodiment 1 of the present invention.

A nonaqueous electrolyte secondary battery in accordance with Embodiment 3 of the present invention can be, for example, a nonaqueous secondary battery that achieves an electromotive force through doping with and dedoping of lithium, and can include a nonaqueous electrolyte secondary battery member including (i) a positive electrode, (ii) the nonaqueous electrolyte secondary battery separator in accordance with Embodiment 1 the present invention, and (iii) a negative electrode, the positive electrode, the nonaqueous electrolyte secondary battery separator, and the negative electrode being arranged in this order. Note that constituent elements of the nonaqueous electrolyte secondary battery other than the nonaqueous electrolyte secondary battery separator are not limited to those described below.

The nonaqueous electrolyte secondary battery in accordance with Embodiment 3 of the present invention is typically configured so that a battery element is enclosed in an exterior member, the battery element including (i) a structure in which the negative electrode and the positive electrode face each other and sandwich the nonaqueous electrolyte secondary battery separator in accordance with Embodiment 1 of the present invention and (ii) an electrolyte with which the structure is impregnated. The nonaqueous electrolyte secondary battery is particularly preferably a lithium-ion secondary battery. Note that the doping refers to occlusion, support, adsorption, or insertion, and refers to a phenomenon in which lithium ions enter an active material of an electrode (e.g., a positive electrode).

The nonaqueous electrolyte secondary battery member in accordance with Embodiment 2 of the present invention includes the nonaqueous electrolyte secondary battery separator in accordance with Embodiment 1 of the present invention, which has an excellent withstand voltage property. As such, the nonaqueous electrolyte secondary battery member in accordance with Embodiment 2 of the present invention brings about the effect of making it possible to produce a nonaqueous electrolyte secondary battery having excellent safety. The nonaqueous electrolyte secondary battery in accordance with Embodiment 3 of the present invention includes the nonaqueous electrolyte secondary battery separator in accordance with Embodiment 1 of the present invention, which has an excellent withstand voltage property. As such, the nonaqueous electrolyte secondary battery in accordance with Embodiment 3 of the present invention brings about the effect of having excellent safety.

<Positive Electrode>

The positive electrode included in (i) the nonaqueous electrolyte secondary battery member in accordance with an embodiment of the present invention and (ii) the nonaqueous electrolyte secondary battery in accordance with an embodiment of the present invention is not limited to a particular one, provided that the positive electrode is one that is typically used in a nonaqueous electrolyte secondary battery. Examples of the positive electrode encompass a positive electrode sheet having a structure in which an active material layer, containing a positive electrode active material and a binding agent, is formed on an electrode current collector. The active material layer may further contain an electrically conductive agent.

Examples of the positive electrode active material encompass materials capable of being doped with and dedoped of lithium ions. Specific examples of such materials encompass lithium complex oxides each containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents can be used in combination.

Examples of the binding agent encompass (i) fluorine-based resins such as polyvinylidene fluoride, (ii) acrylic resin, and (iii) styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

Examples of a method for producing the positive electrode in sheet form encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) then, a positive electrode current collector is coated with the paste, and (iii) subsequently, the paste is dried and then pressured so that the paste is firmly fixed to the positive electrode current collector.

<Negative Electrode>

The negative electrode included in (i) the nonaqueous electrolyte secondary battery member in accordance with an embodiment of the present invention and (ii) the nonaqueous electrolyte secondary battery in accordance with an embodiment of the present invention is not limited to a particular one, provided that the negative electrode is one that is typically used in a nonaqueous electrolyte secondary battery. Examples of the negative electrode encompass a negative electrode sheet having a structure in which an active material layer, containing a negative electrode active material and a binding agent, is formed on an electrode current collector. The active material layer may further contain an electrically conductive agent.

Examples of the negative electrode active material encompass (i) materials capable of being doped with and dedoped of lithium ions, (ii) a lithium metal, and (iii) a lithium alloy. Examples of the materials capable of being doped with and dedoped of lithium ions encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in a lithium-ion secondary battery and is easily processed into a thin film.

Examples of a method for producing the negative electrode in sheet form encompass: a method in which a negative electrode active material is pressure-molded on a negative electrode current collector; and a method in which (i) a negative electrode active material is formed into a paste with the use of a suitable organic solvent, (ii) then, a negative electrode current collector is coated with the paste, and (iii) subsequently, the paste is dried and then pressured so that the paste is firmly fixed to the negative electrode current collector. The paste preferably contains the electrically conductive agent and the binding agent.

<Nonaqueous Electrolyte>

A nonaqueous electrolyte in a nonaqueous electrolyte secondary battery in accordance with an embodiment of the present invention is not limited to any particular one, provided that the nonaqueous electrolyte is one that is generally used for a nonaqueous electrolyte secondary battery. The nonaqueous electrolyte can be one prepared by, for example, dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent to be contained in the nonaqueous electrolyte encompass carbonates, ethers, esters, nitriles, amides, carbamates, and sulfur-containing compounds, and fluorine-containing organic solvents each obtained by introducing a fluorine group into any of these organic solvents. It is possible to use only one kind of the above organic solvents or two or more kinds of the above organic solvents in combination.

### EXAMPLES

The following description will discuss embodiments of the present invention in greater detail with reference to Examples and a Comparative Example. Note, however, that the present invention is not limited to the following Examples and Comparative Example below.

[Measurement Methods]

The methods described below were used to measure physical properties and the like of the nonaqueous electrolyte secondary battery separators (porous films) produced in Examples 1 to 4 and in Comparative Example 1.

[Thickness of Film]

The thickness of the porous film was measured with the use of a high-precision digital measuring device (VL-50) manufactured by Mitutoyo Corporation.

[Weight Per Unit Area]

From the porous film, a square piece measuring 8 cm×8 cm was cut out as a sample, and the weight W (g) of the sample was measured. The following Formula (2) was then used to calculate the weight per unit area of the porous film.

Weight per unit area (g/m²)=W/(0.08×0.08) (2)

[Air Permeability]

The air permeability (Gurley value) of the porous film was measured in conformance with JIS P8117.

[MD Relaxation Ratio]

In each of the Examples and Comparative Example described below, TD-wise ends of a long primary sheet were each held by a plurality of holding members that were arranged so as to be adjacent in the MD. The MD relaxation ratio was calculated using the following Formula (1b′).

MD relaxation ratio (%)−[{(distance between holding members adjacent to each other in MD prior to stretching step)−(distance between holding members adjacent to each other in MD after stretching step))}/(distance between holding members adjacent to each other in MD prior to stretching step)]×100 (1b′)

[Puncture Strength]

The puncture strength of the porous film was measured by a method including the following steps (i) and (ii):

(i) the porous film is fixed with a washer having a diameter of 12 mm, and thereafter a pin (diameter of 1 mm; tip radius of 0.5R) is thrust into the porous film at a speed of 10 mm/sec to a depth of 10 mm; and
(ii) the maximum stress (gf) occurring when the pin is thrust into the porous film in step (i) is measured, and the measured value is considered to be the puncture strength of the porous film.

[Specialized Puncture Test]

The porous film was fixed with a washer having a diameter of 12 mm, and then a pin (diameter of 1 mm; tip radius of 0.5R) was thrust into the porous film at a speed of 1 mm/s to a depth of 2.5 mm. Samples which did not break during this test were considered as passing the test. Note here that “breaking” is defined by measuring stress in the specialized puncture test and determining whether the stress has decreased compared to the stress at the commencement of the test. More specifically, breaking of the porous film refers to the occurrence of a point at which stress in the porous film, which increases simultaneously with commencement of the puncture test, decreases by not less than 200 gf.

[MD Breaking Elongation Ratio, TD Breaking Elongation Ratio]

The MD breaking elongation ratio and the TD breaking elongation ratio of the porous film were measured in conformance with the JIS K7127 standard. Specifics of the measurement method are as follows.

The length of the porous film in the MD was measured. The length of the porous film in the MD thus measured is referred to hereinafter as the “MD length prior to elongation”. Thereafter, the porous film was elongated in the MD, and the length of the porous film in the MD at the time the porous film broke was determined. The length of the porous film in the MD at the time of breaking is referred to hereinafter as the “MD length after elongation”. The MD breaking elongation ratio was then found using the following Formula (3):

MD breaking elongation ratio [% GL]=[{(MD length after elongation)−(MD length prior to elongation)}/(MD length prior to elongation)]×100 (3)

The length of the porous film in the TD was measured in a similar manner. The length of the porous film in the TD thus measured is referred to hereinafter as the “TD length prior to elongation”. Thereafter, the porous film was elongated in the TD, and the length of the porous film in the TD at the time the porous film broke was determined. The length of the porous film in the TD at the time of breaking is referred to hereinafter as the “TD length after elongation”. The TD breaking elongation ratio was then found using the following Formula (4):

TD breaking elongation ratio [% GL]=[{(TD length after elongation)}−(TD length prior to elongation)}/(TD length prior to elongation)]×100 (4)

[Withstand Voltage Test]

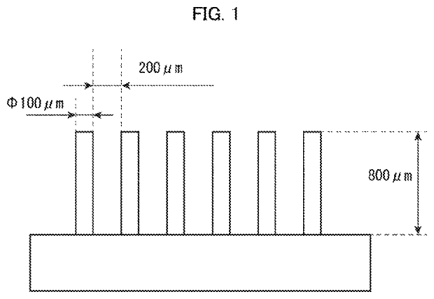

Onto the porous film was placed a cylindrical electrode probe of a withstand voltage tester (TOS9200, manufactured by KIKUSUI). The electrode probe had a diameter of 8 mm and, as illustrated in FIG. 1, had an uneven surface including protrusions each having a diameter of 100 μm and a height of 800 μm. The distance between each of the protrusions was 200 μm. Next, a weight of 400 g was placed onto the electrode probe. Thereafter, a voltage was applied at a rate of 200 mV/sec, and a breakdown voltage was measured. The value of the breakdown voltage thus measured was considered to be the value of the withstand voltage property.

Note that the withstand voltage test simulates the application of voltage while a load is being applied to the nonaqueous electrolyte secondary battery separator during charging and discharging of an actual nonaqueous electrolyte secondary battery. As such, a high value of the withstand voltage property measured in the withstand voltage test indicates that the nonaqueous electrolyte secondary battery separator including the porous film has a favorable withstand voltage property during charging and discharging of an actual nonaqueous electrolyte secondary battery.

### Example 1

First, prepared was a mixture containing: 68 weight % of a ultra-high molecular weight polyethylene powder (intrinsic viscosity: 21 dL/g; viscosity average molecular weight: 3,000,000; manufactured by Tosoh Corporation); and 32 weight % of a polyethylene wax having a weight-average molecular weight of 1000 (FNP-0115, manufactured by Nippon Seiro Co., Ltd.). Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added to 100 parts by weight of the mixture of (i) the ultra-high molecular weight polyethylene and (ii) the polyethylene wax, so as to obtain a second mixture. Then, calcium carbonate having an average particle diameter of 0.1 μm (manufactured by Maruo Calcium Co., Ltd.) was added to the second mixture such that the volume of the calcium carbonate was 38% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained.

A pair of rollers was used to stretch the polyolefin resin composition in the MD to a stretch ratio of 1.4 times, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained. Next, TD-wise ends of the primary sheet thus obtained were each held by a plurality of holding members that were arranged so as to be adjacent in the MD. The primary sheet was stretched in the TD to a stretch ratio of 7 times by increasing the distance between holding members that were opposite each other in the TD. At the same time, the primary sheet was relaxed in the MD by decreasing the distance between holding members that were adjacent in the MD. In this way, a porous film having a thickness of 11 μm was obtained. The porous film thus obtained was considered to be a nonaqueous electrolyte secondary battery separator 1. The MD relaxation ratio was 10%.

### Example 2

A porous film having a thickness of 10 μm was obtained in the same manner as Example 1, except that the MD relaxation ratio was changed to 20%. The porous film thus obtained was considered to be a nonaqueous electrolyte secondary battery separator 2.

### Example 31

A porous film having a thickness of 11 μm was obtained in the same manner as Example 1, except that the MD relaxation ratio was changed to 30%. The porous film thus obtained was considered to be a nonaqueous electrolyte secondary battery separator 3.

### Example 4

A porous film having a thickness of 11 μm was obtained in the same manner as Example 1, except that the MD relaxation ratio was changed to 50%. The porous film thus obtained was considered to be a nonaqueous electrolyte secondary battery separator 4.

### Comparative Example 1

A porous film having a thickness of 13 μm was obtained in the same manner as Example 1, except that the MD relaxation ratio was changed to 0%. The porous film thus obtained was considered to be a nonaqueous electrolyte secondary battery separator 5.

### CONCLUSION

Tables 1 and 2 indicate the MD relaxation ratio and the physical properties measured by the above described methods for the nonaqueous electrolyte secondary battery separators of Examples 1 to 4 and Comparative Example 1. Note that for the specialized puncture test, cases where the porous film did not break are indicated as “Pass”, and cases where the porous film did break are indicated as “Fail”.

TABLE 1

| | Puncture | Air | Weight per |
|---|---|---|---|
| | strength | permeability | unit area |
| | [gf] | [s/100 mL] | [g/m²] |
| Example 1 | 530 | 180 | 7.0 |
| Example 2 | 525 | 165 | 7.4 |
| Example 3 | 480 | 114 | 7.3 |
| Example 4 | 340 | 106 | 7.3 |
| Comparative | 530 | 209 | 7.3 |
| Example 1 | | | |

TABLE 2

| | | | | Withstand | MD breaking | TD breaking |
|---|---|---|---|---|---|---|
| | MD relaxation | | | voltage | elongation | elongation |
| | ratio | Thickness | Specialized | property | ratio | ratio |
| | [%] | [μm] | puncture test | [kV] | [% GL] | [% GL] |
| Example 1 | 10 | 11.4 | Pass | 0.47 | 25 | 106 |
| Example 2 | 20 | 10.4 | Pass | 0.67 | 33 | 115 |
| Example 3 | 30 | 10.8 | Pass | 0.66 | 85 | 90 |
| Example 4 | 50 | 10.5 | Pass | 0.82 | 209 | 63 |
| Comparative | 0 | 13.0 | Fail | 0.23 | 13 | 94 |
| Example 1 | | | | | | |

As shown in Table 2, the nonaqueous electrolyte secondary battery separators 1 to 4 of Examples 1 to 4 and the nonaqueous electrolyte secondary battery separator 5 of Comparative Example 1 each have similar thicknesses. However, the nonaqueous electrolyte secondary battery separators 1 to 4 of Examples 1 to 4 did not break in the specialized puncture test, whereas the nonaqueous electrolyte secondary battery separator 5 of Comparative Example 1 did. As such, it was found that, in comparison to the nonaqueous electrolyte secondary battery separator 5 of Comparative Example 1, the nonaqueous electrolyte secondary battery separators 1 to 4 of Examples 1 to 4 had excellent strength with respect to elongation. The nonaqueous electrolyte secondary battery separators 1 to 4 of Examples 1 to 4 each had an MD breaking elongation ratio that was improved as compared to the nonaqueous electrolyte secondary battery separator 5 of Comparative Example 1.

Furthermore, it was found that the nonaqueous electrolyte secondary battery separators 1 to 4 of Examples 1 to 4, which did not break in the specialized puncture test, each had a better withstand voltage property than the nonaqueous electrolyte secondary battery separator 5 of Comparative Example 1.

### INDUSTRIAL APPLICABILITY

An aspect of the present invention can be used in producing a nonaqueous electrolyte secondary battery which has excellent safety due to the inclusion of a nonaqueous electrolyte secondary battery separator having an excellent withstand voltage property.

1. A nonaqueous electrolyte secondary battery separator comprising:
a polyolefin porous film,
the polyolefin porous film having a thickness of 4 μm to 40 μm,
the polyolefin porous film not breaking in a puncture test in which a pin having a diameter of 1 mm and tip radius of 0.5R is thrust into the polyolefin porous film at a speed of 1 mm/s to a depth of 2.5 mm,
where breaking of the polyolefin porous film refers to the occurrence of a point at which stress in the polyolefin porous film, which increases simultaneously with commencement of the puncture test, decreases by not less than 200 gf.

2. The nonaqueous electrolyte secondary battery separator according to claim 1, wherein the polyolefin porous film has a MD breaking elongation ratio of not less than 20% GL,
the MD breaking elongation ratio being measured by a method in conformance with the JIS K7127 standard.

3. The nonaqueous electrolyte secondary battery separator according to claim 1, further comprising:
an insulating porous layer including one or more types of resin selected from the group consisting of polyolefins, (meth)acrylate-based resins, fluorine-containing resins, polyamide-based resins, polyester-based resins, and water-soluble polymers.

4. The nonaqueous electrolyte secondary battery separator according to claim 3, wherein the resin is an aramid resin.

5. A nonaqueous electrolyte secondary battery member comprising:
a positive electrode;
a nonaqueous electrolyte secondary battery separator according to claim 1; and
a negative electrode,
the positive electrode, the nonaqueous electrolyte secondary battery separator, and the negative electrode being arranged in this order.

6. A nonaqueous electrolyte secondary battery comprising:
the nonaqueous electrolyte secondary battery separator according to claim 1.
